(19) United States
(12) Patent Application Publication
(10) Pub. No.: US 2007/0037942 A1
(43) Pub. Date: Feb. 15, 2007

(54) Preparation of reactive polymeric nanoparticles

(76) Inventors: Janos Borbely, Debrecen (HU); Csaba Hegedus, Debrecen (HU); Melinda Szaloki, (US)

Correspondence Address: Bodner & O'Rourke, 425 Broadhollow Road, Melville, NY, 11747, US

(21) Appl. No.: 11/482,540

(22) Filed: Jul. 7, 2006

Related U.S. Application Data
(60) Provisional application No. 60/697,396, filed on Jul. 7, 2005.

(51) Int. Cl. C08F 4/30

(52) U.S. Cl. 526/229; 526/319; 526/346

(57) ABSTRACT

Reactive polymeric nanoparticles formed from the reaction product of a mono vinyl monomer and a di/tri/multivinyl monomer are disclosed

This application claims priority on U.S. Provisional Patent application Ser. No. 60/697,396 filed Jul. 7, 2005, the disclosures of which are incorporated herein by reference.

### FIELD OF THE INVENTION

The present invention is directed to improved polymeric nanoparticles. More particularly, the present invention relates to reactive nanoparticles prepared by, for example, a free radical non-linear copolymerization of mono (M₁) and di/tri/multivinyl (M₂) monomers in a miniemulsion.

### BACKGROUND OF THE INVENTION

There is significant interest in preparing a variety of polymeric nanoparticles in which the size, surface features and functionalities of the nanoparticles can be controlled. Crosslinking polymerization methods in preparing polymeric nanoparticles have received considerable interest relating to the preparation of microgels, crosslinked nanoparticles, their composites, and to the study of gelation reactions. Crosslinked systems have many commercial applications, one primary application for cross linked polymeric nanoparticles is in restorative dentistry, as well as paints and powder coatings. Other applications for polymeric nanoparticles include catalysis, pharmaceuticals, particularly controlled release devices, biostructured fillers, electronics and polymeric composites.

Processes that have been used to generate polymeric nanoparticles include solution polymerization and dispersion polymerization. Emulsion polymerization can be used to produce small particles, generally having a mean particle size of greater than 50 nanometers, at high solid levels by using dilute conditions and/or high levels of dispersing agents such as surfactants.

Crosslinked nanoparticles are typically formed in homogeneous solutions or in an emulsion medium. Crosslinking is typically accomplished during polymerization by using a multifunctional reactant or by a post reaction in which polymer chains are linked together through functional groups.

In the area of dental filling materials, polymeric nanoparticles have been the subject of great interest. For dental filling materials, multivinyl monomers were recently crosslinked in situ by a photopolymerization process. Contraction of dental composites is a significant problem in dentistry. Volumetric shrinkage can compromise marginal seals and rupture adhesive bonds created at the tooth restorative interface. Additionally, allergic reactions generated by residual monomers may affect some patients.

In Soane, U.S. Pat. No. 6,607,994, the disclosure is directed to preparations useful for the permanent or substantially permanent treatment of textiles and other webs. More particularly, the preparations of the invention includes an agent or other payload surrounded by or contained within a polymeric encapsulator that is reactive to webs, to give textile-reactive nanoparticles. By “textile-reactive” is meant that the payload nanoparticle will form a chemical covalent bond with the fiber, yarn, fabric, textile, finished goods (including apparel), or other web or substrate to be treated. The polymeric encapsulator of the payload nanoparticle has a surface that includes functional groups for binding or attachment to the fibers of the textiles or other webs to be treated, to provide permanent attachment of the payload to the textiles. Alternatively, the surface of the nanoparticle includes functional groups that can bind to a linker molecule that will in turn bind or attach the nanoparticle to the fiber. This invention is further directed to the fibers, yarns, fabrics, other textiles, or finished goods treated with the textile-reactive nanoparticles. Such textiles and webs exhibit a greatly improved retention or durability of the payload agent and its activity, even after multiple washings.

Frankel, U.S. Pat. No. 5,252,657 is directed to modified aqueous dispersions of water-insoluble latex polymer prepared by swelling an initial water-insoluble latex polymer, prepared by emulsion polymerization, with additional ethylenically unsaturated monomer, including at least one monomer with two or more sites of ethylenic unsaturation, and subsequently polymerizing the additional monomer within the swollen latex particles.

In Leon, U.S. Pat. No. 6,986,944, combustible core-shell particles have a nitro-resin core that is covered by an addition polymer shell in a weight ratio of from 20:1 to 0.2:1 (core:shell). The shell polymer is derived from one or more ethylenically unsaturated polymerizable monomers that are represented by the following Structure I: CH.sub.2.dbd.C(R)-X (I) wherein R is hydrogen or methyl, and X is any monovalent moiety except a phenyl group. These combustible core-shell particles are particularly useful in thermal imaging materials such as “direct-write” printing plate precursors.

Dental composite compositions, restorative compositions, and methods for their use are provided in Yin, U.S. Pat. No. 6,709,271. The compositions can contain (a) from about 1 to about 35 weight percent of a monomer portion containing at least one monomer having a functional group capable of undergoing polymerization; (b) from about 75 to about 95 weight percent of a filler portion, the filler portion containing at least a spherical filler portion having at least one spherical filler particle component; and (c) from about 0.01 to about 10 weight percent of a polymerization catalyst portion containing at least one catalyst capable of assisting in the polymerization of the functional group of the monomer portion and hardening of the composite after application of the composite to a tooth surface or other dental surface. The spherical filler portion is present in an amount sufficient to reduce shrinkage of the composite after polymerization to about 1.8 percent or less. Compositions according to the invention are useful in Class I, II, IV, V, Core build-ups, and other types of dental restorations where maximum strength and polishability are desired. Methods for using such compositions in such restorative procedures are also provided.

Esser, U.S. Pat. No. 5,609,965 claims an aqueous polymeric formulation. Also disclosed are methods of making the polymeric formulation, and of using the polymeric formulation to produce a crosslinked polymeric surface coating on a substrate. One embodiment of the novel polymeric formulation comprises an aqueous carrier; at least one polymeric ingredient; a non-polymeric polyfunctional amine; and base. The one polymeric ingredient has both acid-functional and acetoacetoxy-type functional pendant moieties. The non-polymeric polyfunctional amine has at least two amine-functional moieties. The amount of base contained within the formulation is effective for inhibiting gellation, which would otherwise occur as a result of crosslinking between the acetoacetoxy-type functional and amine-functional moieties. Another embodiment of the novel polymeric formulation comprises at least two polymeric ingredients, one of which has acetoacetoxy-type functional pendant moieties and the other of which has acid-functional pendant moieties.

In Jia, U.S. Pat. No. 6,730,715 A curable dental restorative composition is disclosed. The composition has about 1 to about 90 wt %, based on the total weight of the composition, of a filler component, the filler component comprising about 10 to 100 wt %, based on the total weight of the filler component, of a surface reactive glass component; about 1 to about 50 wt %, based on the total weight of the composition, of water; and about 10 to about 97 wt %, based on the total weight of the composition, of a curable organic component, comprising about 50 to about 99 wt %, based on the total weight of the curable organic component, of an ethylenically unsaturated resin component, about 1 to about 50 wt %, based on the total weight of the curable organic component, of an ethylenically unsaturated phosphoric acid ester; and about 0.01 to about 5 wt % of a curing system.Another patent to Jia, U.S. Pat. No. 6,417,246 is directed to a polymerizable dental composition, comprising a polymerizable resin composition; and a filler composition comprising a bound, nanostructured colloidal silica.

Yang, U.S. Pat No. 5,969,000 describes a dental resin composition comprising an ethoxylated bisphenol A dimethacrylate having the formula wherein x+y is an integer from 1 to 20, and preferably from 2 to 7, together with a methacrylate oligomer and an optional diluent monomer. The composition is suitable for use for dental fillers adhesives, and the like, and has improved water sorption and excellent wear resistance.

In Waknine, U.S. Pat No. 5,444,104 a polycarbonate dimethacrylate is disclosed which is the condensation product of 2 parts of hydroxyalkylmethacrylate of the formula. ##STR1## in which A is C.sub.1-C.sub.6 alkylene, and 1 part of a bis(chloroformate) of the formula ##STR2## in which R is C.sub.2-C.sub.5 alkylene having at least two carbon atoms in its principal chain and n is an integer from 1 to 4, is usable, admixed with a secondary monomer suitable for dental applications, such as BIS-GMA; UDMA or the like, as an adhesive system for dental restorative materials. Particularly useful is the novel condensation product of 2-hydroxyethylmethacrylate and triethylene glycol bis(chloroformate). Dental adhesives containing these components are suitable for application to enamel, pretreated dentin, porcelain and metallic surfaces. The dentin surfaces are pretreated by application of an alcoholic solution of an alkali metal salt of benzene sulfinic acid. The resinous adhesives of the invention can be used in dental compositions which are visible lighting curing, self-curing, dual curing, heat and pressuring curing, or any combination thereof. Where the resinous adhesive is a self-curing adhesive, the polymerization accelerator, which is a tertiary amine such as dihydroxyethyl-p-toluidine, can optionally be incorporated into the alcoholic pretreatment solution. The condensation product is also suitable for use in filled compositions in which the filler material comprises inorganic silicates.

In Hallock, U.S. Pat No. 5,869,220 photoresist emulsions are prepared using low levels of neutralization while minimizing the use of surfactants and associative thickeners. High solids, low viscosity waterborne photoresist emulsion compositions are prepared by mixing and comminuting a partially neutralized acid functional latex polymer resin with photopolymerizable monomers and photoinitiators under conditions sufficient to produce a stable emulsion.

### OBJECTS OF THE INVENTION

It is an object of the intention to provide an improved polymeric nanoparticles.

It is also an object of the invention to provide an improved nanoparticle that is cross linked.

It is another object of the invention to provide a polymeric nanoparticle made from a free radical non-linear copolymerization process.

It is a still further object of the invention to provide a reactive polymeric nanoparticle that is made from a mono and trivinyl acrylic monomer.

It is still another object of the invention to provide a reactive polymeric nanoparticles made in a miniemulsion.

It is a still further object of the invention to provide a reactive polymeric nanoparticle that is suitable for a variety of applications.

It is also an object of the invention to provide a reactive polymeric nanoparticle that is suitable for use as a component in powder based coatings.

It is another object of the invention to provide a reactive polymeric nanoparticle that is useful in dental filling materials.

It is still another object of the invention to provide a method for making reactive polymeric nanoparticles.

### SUMMARY OF THE INVENTION

The present invention is directed broadly to reactive polymeric nanoparticles prepared, for example, by a free radical non-linear copolymerization of mono (M₁) and trivinyl acrylic (M₂) monomers in a miniemulsion. The nanoparticles so formed may be crosslinked. The amount of crosslinking is usually dependent on the amount of the trivinyl component present in the reaction mixture. The size of the polymer formed by the process is also dependent upon ratio of M₂ monomer due to its higher polarity in the aqueous medium. The reactive polymeric nanoparticles produced by this method range in size from about 50 to about 500 mm. The particles of the present invention are useful in a variety of applications. Two applications in particular are dental filling material and as a component in powder based coatings.

The method of the present invention produces reactive polymeric nanoparticles in a miniemulsion process with low to high cross-linking density. In the process, dispersion of droplets of mono and trivinyl monomers prevented gelation while allowing the growth of the particles. Nanoparticles with reactive vinyl groups have potential use as dental materials. Because the major portion of polymerization is performed prior to the application by the dentist, limited volumetric shrinkage is expected during the final in situ photopolymerization step. Furthermore and importantly, sensitive patients will not be exposed to irritating monomers.

The nanoparticles of the present invention can, for example, be produced in a miniemulsion copolymerization of styrene (M₁, ST) and trimethylol propane trimethacrylate (M₂ TMPTMA) using a monomer feed where the ratio of M₁/M₂ can typically range from about 9/1 to 1/9.

The reaction can include one or more surfactants as well as one or more initiators. A preferred surfactant is sodium dodecyl sulfate (SDS). A preferred initiator is potassium peroxide. In the reaction vessel, the RPNP's can be precipitated out by a suitable solvent such as methyl alcohol. The resulting particles can be purified by, for example, dissolving in toluene.

If the size of the particles sought to be produced are large, this can be accomplished by increasing the percentage of the monomer M₂. The resultant feed has larger latex particles.

The preparation of RPNPs was performed by crosslinking polymerization. The size of the particles depended upon the monomer ratio and on the nature, hydrophilicity and hydrophobicity of the monomers applied. The reactivity of particles was due to the adjacent vinyl groups. The reactivity increased with the ratio of crosslinker. The swelling ratio decreased with the crosslink density. Nanoparticles produced by this method have a potential use as dental filling materials and as a component of industrial powder coatings.

### BRIEF DESCRIPTION OF THE DRAWINGS

FIG. 1 is a representation of the reaction scheme for the process of the present invention.

FIG. 2 is a ¹H NMR spectra of reactive polymeric nanoparticles of the present invention.

FIG. 3 is a ¹H NMR spectra of reactive polymeric nanoparticles of the present invention.

FIG. 4 A, B shows mixtures of water and monomers before and after sonication.

FIG. 5 is a graph of particle size of latex reactive polymeric nanoparticles measured by DLS.

FIG. 6 shows a representation of two compositions of nano droplets before polymerization.

FIG. 7 is a graph showing particle size of reactive polymeric nanoparticles in toluene as measured by DLS.

FIG. 8 shows a graph of transmittance values of the monomer feed.

FIG. 9 shows SEM micrographs of reactive polymeric nanoparticles prepared with M₁/M₂ monomer feed.

FIG. 10 shows SEM micrographs of reactive polymeric nanoparticles and histograms for size distribution.

FIG. 11 shows DSC thermograms of samples with a monomer feed.

### DETAILED DESCRIPTION OF THE INVENTION

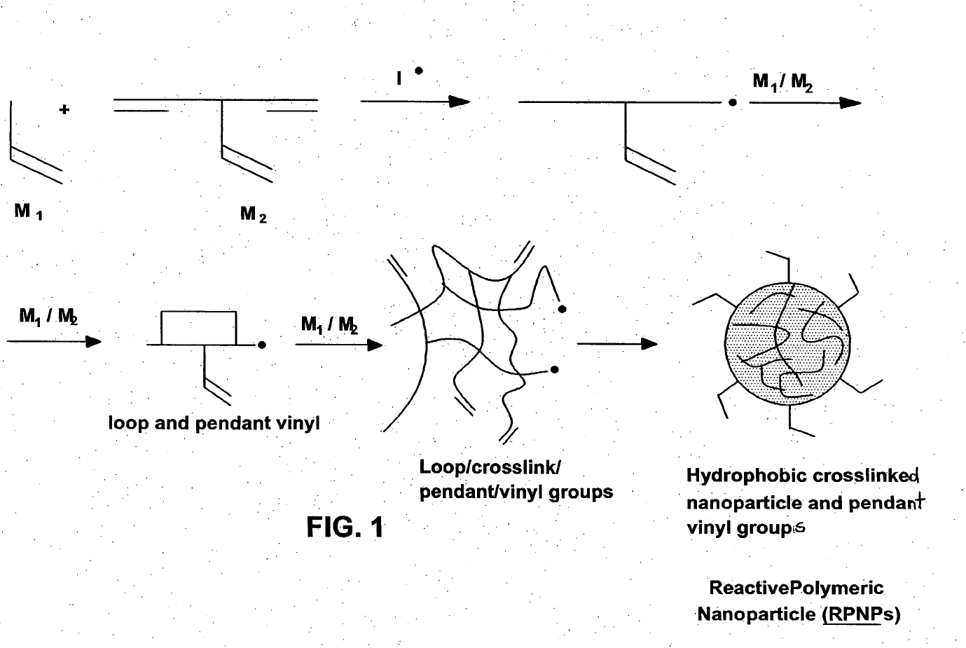

The general steps of forming the nanoparticles of the present invention is shown in FIG. 1. A mono vinyl acrylic monomer (M₁) is combined with a di/tri/multivinyl monomer in a miniemulsion to form a growing linear macroradical chain with pendant vinyl group. Some of the trivinyl acrylic monomers useful in the present invention include polyacrylic and polymethacrylic esters of polyols such as butylene diocrytate and dimethacrylate, trimethylol propane, trimethacrylate, trivinyl benzene, trivinyl toluene, trivinyl xylene and alphatic trivinyl monomers and the like. Examples of the monovinyl acrylic monomers that can be used in the present invention include aromatic monovinyl monomers such as styrene methyl, styrene, ethyl styrene, chlorostyrene, vinyl benzoyl chloride, etc. and alphatic monovinyl monomers such as acrylic acid, methacrylic acid, ethyl acrylate, butyl acrylate, methyl methacrylate, ethyl methacrylate, butyl methacrylate, etc. The pendant double bonds of these monomers form primary and secondary loops followed by branching and crosslinking. The final nanoparticles contain double bonds which are susceptible to further thermal or photo-activated post polymerization.

In accordance with the present invention nanoparticles were prepared by miniemulsion copolymerization of a mono vinyl acrylic monomer such as styrene (M₁, ST) and a trivinyl monomer. One suitable trivinyl monomer is trimethylol propane trimethacrylate (M₂, TMPTMA). The preferred composition can range from about 1% by weight of the mono vinyl monomer to about 99% by weight of the trivinyl monomer. Preferred monomer feeds can include M₁/M₂=9/1, 7/3, 5/5, 3/7 and 1/9 mol ratio at 60 C. The reaction may also include one or more surfactants and/or initiators. A preferred surfactant is sodium dodecyl sulfate (SDS). A preferred initiator is potassium peroxide. RPNPs can be precipitated by adding, for example, an excess of methyl alcohol. The particles can be purified by dissolving in toluene and precipitated with methyl alcohol. The isolated nanoparticles can be dissolved or dispersed in toluene and in chloroform.

Monovinyl Monomers:

Specific examples of suitable core co-monomers that are useful to form a linear vinyl monomer include but are not limited to the following: (meth)acrylate esters such as methyl(meth)acrylate, ethyl(meth)acrylate, n-propyl(meth)acrylate, n-butyl(meth)acrylate, iso-propyl(meth)acrylate, iso-butyl(meth)acrylate, tertiary butyl(meth)acrylate, neopentyl-(meth)acrylate, iso-penthyl(meth)acrylate, n-amyl(meth)acrylate, n-heptyl(meth)acrylate, iso-heptyl(meth)acrylate, n-hexyl(meth)acrylate, n-octyl(methacrylate), iso-octyl(methacrylate), iso-amyl(meth)acrylate, 2-hydroxyethyl(meth)acrylate, 2-hydroxypropyl(meth)acrylate, N,N-dimethylaminoethyl(meth)acrylate, N,N-diethylaminoethyl(meth)acrylate, t-butylaminoethyl(meth)acrylate, 2-sulfoethyl(meth)acrylate, trifluoroethyl(meth)acrylate, glycidyl(meth)acrylate, benzyl(meth)acrylate, allyl(meth)acrylate, 2-n-butoxyethyl(meth)acrylate, 2-chloroethyl(meth)acrylate, sec-butyl-(meth)acrylate, tert-butyl(meth)acrylate, 2-ethylbutyl(meth)acrylate, cinnamyl(meth)acrylate, crotyl(meth)acrylate, cyclohexyl(meth)acrylate, cyclopentyl(meth)acrylate, 2-ethoxyethyl(meth)acrylate, furfuryl(meth)acrylate, hexafluoroisopropyl(meth)acrylate, methallyl(meth)acrylate, 3-methoxybutyl(meth)acrylate, 2-methoxybutyl(meth)acrylate, 2-nitro-2-methylpropyl(meth)acrylate, 2-ethylhexyl(meth)acrylate, lauryl(meth)acrylate, 2-phenoxyethyl(meth)acrylate, 2-phenylethyl(meth)acrylate, phenyl(meth)acrylate, propargyl(meth)acrylate, tetrahydrofurfuryl(meth)acrylate, norbornyl(meth)acrylate, tetrahydropyranyl(meth)acrylate, vinyl acetate, (meth)acrylonitrile, vinylpropionate, vinylidene chloride, (meth)acrylamide, N-methylolacrylamide, benzyl(meth)acrylate, iso-octyl(methacrylate),2-ethylhexyl(meth)acrylate, octadecyl methacrylate, octadecyl acrylate, nonyl(meth)acrylate, iso-nonyl(meth)acrylate, decyl(meth)acrylate, iso-decyl(meth)acrylate, undecyl(meth)acrylate, iso-undecyl(meth)acrylate, tridecyl(meth)acrylate, iso-tridecyl(meth)acrylate, tetradecyl(meth)acrylate, iso-tetradecyl(meth)acrylate, lauryl(meth)acrylate, iso-lauryl(meth)acrylate, hydroxyethyl(meth)acrylate, hydroxyhexyl(meth)acrylate, hydroxyoctadecyl(meth)acrylate, hydroxylauryl(meth)acrylate, phenethyl(meth)acrylate, 6-phenylhexyl(meth)acrylate, phenyllauryl(meth)acrylate, 3-nitrophenyl-6-hexyl methacrylate, 3-nitrophenyl-18-octadecyl acrylate, ethyleneglycol dicycopentyl ether acrylate, vinyl ethyl ketone, vinyl propyl ketone, vinyl hexyl ketone, vinyl octyl ketone, vinyl butylketone, cyclohexyl acrylate, 3-methacryloxypropyldimethylmethoxysilane, 3-methacryloxypropylmethyldimethoxysilane, 3-methacryloxypropylpentamethy-disiloxane, 3-methacryloxypropyltris(trimethylsiloxy)silane, 3-acryloxypropyldimethylmethoxysilane, acryloxypropylmethyldimethoxysilan, trifluoromethyl styrene, trifluoromethyl(meth)acrylate, tetrafluoropropyl(meth)acrylate, heptafluorobutyl methacrylate, N,N-dihexyl acrylamide, N,N-dioctyl acrylamide, aminoethylacrylate, aminoethyl methacrylate, aminoethyl butacrylate, aminoethylphenyl acrylate, aminopropyl(meth)acrylate, aminoisopropyl(meth)acrylate, aminobutyl(meth)acrylate, aminohexyl(meth)acrylate, aminooctadecyl(meth)acrylate, aminolauryl(meth)acrylate, N,N-dimethyl-aminoethyl(meth)acrylate, N,N-diethylaminoethyl(meth)acrylate, piperidino-N-ethyl acrylate, vinyl propionate, vinylacetate, vinyl butyrate, vinyl butyl ether, vinyl propyl ether, styrene and alkyl derivatives

Di- and Multivinyl Monomers

Crosslinking monomers suitable for use as the cross-linker in the core polymer are known to those skilled in the art, and are generally di- and higher multifunctional monomers copolymerizable with the other core monomers, as for example, glycol dimethacrylates and acrylates, triol triacrylates and methacrylates and the like. The preferred crosslinking monomers are butylene glycol diacrylates.

Crosslinking monomers include: N,N′-methylene-bis-acrylamide, ethylene glycol di(meth)acrylate (EGD(M)A), diethylene glycol di(meth)acrylate, triethylene glycol di(meth)acrylate, tetraethylene glycol di(meth)acrylate, polyethylene glycol di(meth)acrylate, propylene glycol di(meth)acrylate, hexanediacrylate, cyclohexanedimethanoldivinil ester, polypropylene glycol di(meth)acrylate, butanediol di(meth)acrylate(BDDMA), hexanediol di(meth)acrylate, pentaerythritol tri(meth)acrylate, trimethylolethane tri(meth)acrylate, trimethylolpropane di(meth)acrylate, trimethylolpropane tri(meth)acrylate (TMPT(M)A), tripropylene glycol di(meth)acrylate, neopentyl glycol di(meth)acrylate, dipropylene glycol di(meth)acrylate, hacrylate, divinyl benzene, allyl(meth)acrylate (AL(M)A), divinyl benzene (DVB), glycidyl methacrylate, 2,2-dimethylpropane 1,3 diacrylate, 1,3-butylene glycol diacrylate, 1,3-butylene glycol dimethacrylate, 1,3-butadienol di(meth)acrylate, 1,4-butanediol di(meth)acrylate, 1,6-hexanediol di(meth)acrylate, polyethylene glycol 200 diacrylate, ethoxylated bisphenol A di(meth)acrylate, polyethylene glycol 600 dimethacrylate, poly(butanediol) diacrylate, trimethylolpropane tri(meth)acrylate, pentaerythritol tri(meth)acrylate (PETA), trimethylolpropane triethoxy tri(meth)acrylate, glyceryl propoxy tri(meth)acrylate, pentaerythritol tetra(meth)acrylate, and dipentaerythritol monohydroxypentaacrylate.

Monomers Which are Used in Dental Resins:

Bis-phenol-A-dimethacrylate (Bis-EMA), bis-phenol-A-bis-glycidyl methacrylate (Bis-GMA), diethylene glycol dimethacrylate, triethylene glycol dimethacrylate (TEGMA), urethane dimethacrylate (UDMA), polyurethanedimethacrylate, diurethane dimethacrylate (DUDMA), polycarbonate dimethacrylate (PCDMA), ethoxylated bis-phenol-A-dimethacrylate (EBPDMA) diethylaminoethyl(meth)acrylate, (commonly referred to as “DEA-EMA”), dimethylamino ethyl methacrylate, diethylaminoethyl methacrylate (DEAEMA), ethyleneglycol dimethacrylate, tetramethylene glycol dimethacrylate, trimethylol propyl trimethacrylate, 1,6-hexanediol dimethacrylate, 1,3-butanediol dimethacrylate, and the like.

Surfactants Which can be Used at Emulsion:

Anionic surfactants: salts of carboxylic acid, sulfates, salts of sulfuric acid, phosphates. Cationic surfactants: ammonium salt, N-alkyl-pyridine salt. Non-ionic surfactants: fatty acid ester of polyols. Amphoteric surfactants: derivative of betains.

The surfactant can be an ionic or nonionic surfactant.

Ionic Surfactants include but are not limited to: Sodium 1-decanesulfonate, 4-(2,3-Dihydroxypropyl) 2-(2-methylene-4,4-dimethylpentyl)succinate potassium salt, Sodium dodecyl sulfate, Sodium dodecylbenzenesulfonate, Glycolic acid ethoxylate 4-nonylphenyl ether, Glycolic acid ethoxylate 4-tert-butylphenyl ether, Glycolic acid ethoxylate lauryl ether, Glycolic acid ethoxylate octyl ether, N,N-Dimethyl-N-[3-(sulfooxy)propyl]-1-nonanaminium hydroxide, N,N-Dimethyl-N-[3-(sulfooxy)propyl]-1-decanaminium hydroxide, N-Ethyl-N-[(heptadecafluorooctyl)sulfonyl]glycine potassium salt, Poly(ethylene glycol) n-alkyl 3-sulfopropyl ether potassium salt, Poly(ethylene glycol) 4-nonylphenyl 3-sulfopropyl ether potassium salt.

Non-ionic Surfactants include but are not limited to: 2,4,7,9-Tetramethyl-5-decyne-4,7-diol ethoxylate, 2,4,7,9-Tetramethyl-5-decyne-4,7-diol ethoxylate, 2,4,7,9-Tetramethyl-5-decyne-4,7-diol ethoxylate, 2,4,7,9-Tetramethyl-5-decyne-4,7-diol, 2,5-Dimethyl-3-hexyne-2,5-diol, 8-Methyl-1-nonanol propoxylate-block-ethoxylate, Ethylenediamine tetrakis(ethoxylate-block-propoxylate) tetrol, Poly[dimethylsiloxane-co-methyl(3-hydroxypropyl)siloxane]-graft-poly(ethylene/propylene glycol), Poly(ethylene glycol) n-alkyl 3-sulfopropyl ether potassium salt, Poly(ethylene glycol) myristyl tallow ether, Poly(ethylene glycol)-block-poly(propylene glycol)-block-poly(ethylene glycol), Polyethylene-block-poly(ethylene glycol), Polyoxyethylene sorbitan tetraoleate, Polyoxyethylene sorbitol hexaoleate, Polyoxyethylene(12) tridecyl ether, Polyoxyethylene(18) tridecyl ether, Polyoxyethylene(6) tridecyl ether, Sorbitan monooleate, Sorbitan sesquioleate and Sorbitan trioleate.

The initiator can be but is not limited to thermal or photoinitiators.

Thermal Initiators can include:

αα′ Azoisobutironitrile(AIBN), 4,4′-Azobis(4-cyanovaleric acid), 1,1′-Azobis(cyclohexanecarbonitrile), 2,2′-Azobis(2-methylpropionitrile), Benzoyl peroxide reagent grade, 2,2-Bis(tert-butylperoxy)butane, 2,5-Bis(tert-butylperoxy)-2,5-dimethylhexane, Bis[1-(tert-butylperoxy)-1-methylethyl]benzene tert-Butyl hydroperoxide, tert-Butyl peracetate, tert-Butyl peroxide 98% Cumene hydroperoxide, Dicumyl peroxide, Lauroyl peroxide, Peracetic acid and Potassium persulfate.

Photoinitiators can include:

Diphenyl(2,4,6-trimethylbenzoyl)phosphine oxide, 4,4′-Dimethoxybenzoin, Anthraquinone, Anthraquinone-2-sulfonic acid Sodium salt, Benzene-chromium(0) tricarbonyl, 4-(Boc-aminomethyl)phenyl isothiocyanate, Benzil, Benzoin purified, Benzoin ethyl ether, Benzoin isobutyl ether, Benzophenone, Benzoic acid meets, Benzophenone/1-hydroxycyclohexyl phenyl ketone, Benzophenone-3,3′,4,4′-tetracarboxylic dianhydride, 4-Benzoylbiphenyl, 2-Benzyl-2-(dimethylamino)-4′-morpholinobutyrophenone, 4,4′-Bis(diethylamino)benzophenone, Camphorquinone, 2-Chlorothioxanthen-9-one, 5-Dibenzosuberenone, 2,2-Diethoxyacetophenone, 4,4′-Dihydroxybenzophenone, 2,2-Dimethoxy-2-phenylacetophenone, 4-(Dimethylamino)benzophenone, 4,4′-Dimethylbenzil, 3,4-Dimethylbenzophenone, Diphenyl(2,4,6-trimethylbenzoyl)phosphine oxide/2-hydroxy-2-methylpropiophenone, 4′-Ethoxyacetophenone, 2-Ethylanthraquinone, Ferrocene, 3′-Hydroxyacetophenone, 4′-Hydroxyacetophenone, 3-Hydroxybenzophenone, 4-Hydroxybenzophenone, 1-Hydroxycyclohexyl phenyl ketone, 2-Hydroxy-2-methylpropiophenone, 2-Hydroxy-2-methylpropiophenone, 2-Methylbenzophenone, 3-Methylbenzophenone, Methyl benzoylformate, 2-Methyl-4′-(methylthio)-2-morpholinopropiophenone, 9,10-Phenanthrenequinone, 4′-Phenoxyacetophenone, Thioxanthen-9-one, Triarylsulfonium hexafluorophosphate salts, 3-Mercapto-1-propanol, 11-Mercapto-1-undecanol, 1-Mercapto-2-propanol and 3-Mercapto-2-butanol.

The structure of RPNPs formed in accordance with the present invention can be determined by ¹H NMR spectroscopy. ¹H NMR experiments were performed on Bruker 200 WP instrument at 200 MHz operating frequency in CDCl₃ solution at an RPNP concentration of 20 mg/ml. Peaks assigned for the aromatic region of the M₁ monomer were in the range of 6.3-7.3 ppm, and aliphatic protons at 0.6-2.3 ppm. Signals of reactive pendant vinyl groups were in the range of 5.5-6.2 ppm.

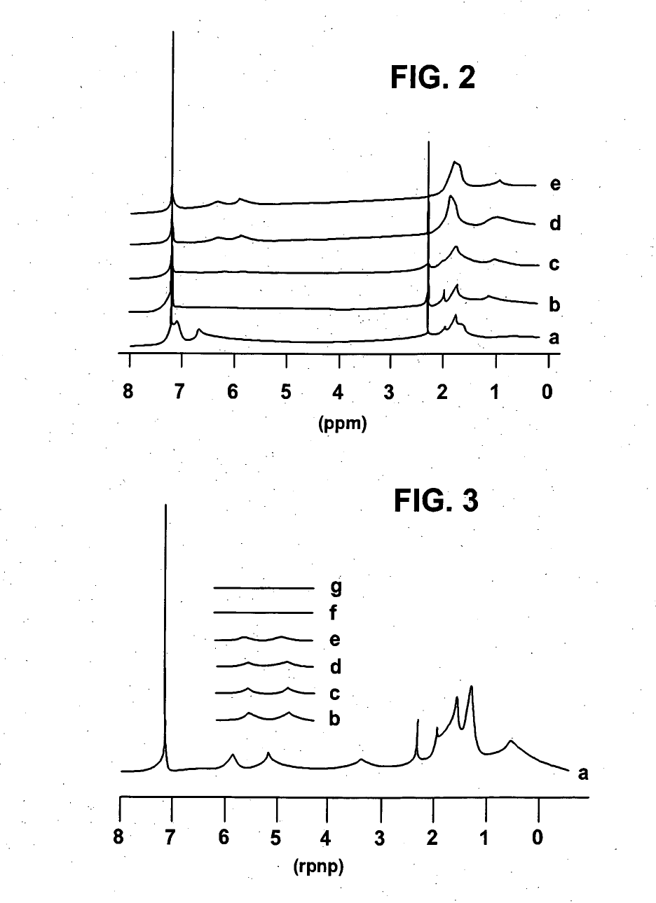

FIG. 2 shows ¹H NMR spectra of RPNPs samples. M₁/M₂ in the monomer feed: a: 9/1; b: 3/7; c: 5/5; d: 3/7 and e: 1/9 (at 120 min reaction time). In a and b samples the vinyl signals are very low. At higher M₂ content, an intensification of vinyl peaks was observed (d and e). In FIG. 3 the ¹H NMR spectra of RPNP with M₁/M₂=5/5 monomer feed at extended reaction time is shown. The extended reaction time is as follows: a: 20 min; b: 40 min; c: 60 min; d: 90 min; e: 120 min; f: 240 min and g: 480 min. In the early stage of polymerization highly reactive particles were formed (a and b). At 120 min reaction time with a conversion of 95 % reactive particles were still observed (e). However, at prolonged reaction the vinyl signals were decreased to near low intensity (f and g).

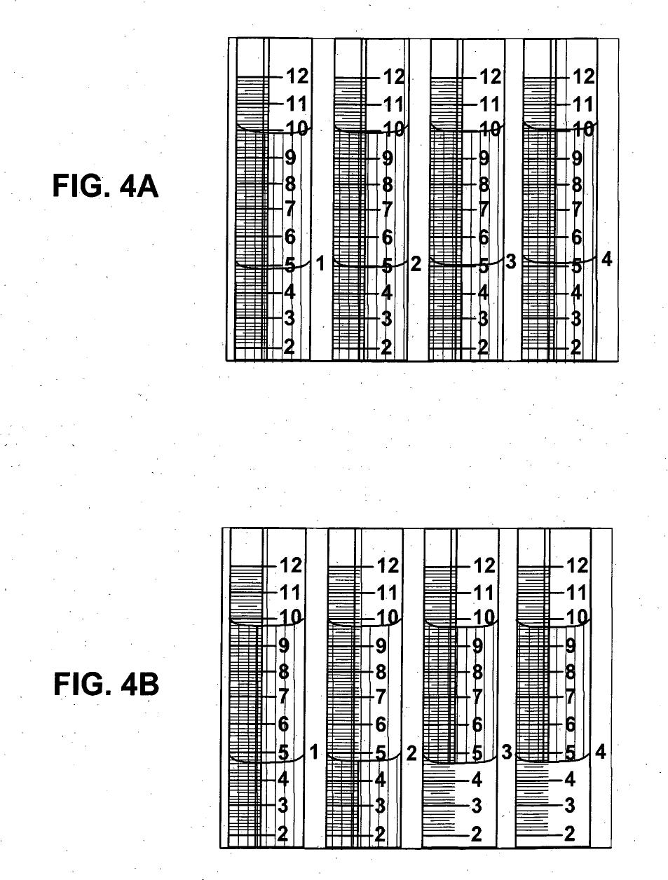

Once the particles were formed, the particle size was determined. Miniemulsion mixtures of M₁ and M₂ were in 50 ml of deionized water and 1 g of SDS. The total volume of monomers was 2 ml and the monomer feed values were M₁/M₂=9/1, 7/3; 5/5; 3/7 and 1/9, respectively. The M₂ monomer has low solubility in water, and was also miscible in the organic phase. FIG. 4 shows the liquid phases of monomers and water in the absence of surfactant. Thus, FIG. 4 depicts mixtures of water and monomers (A before sonication, B after sonication). Volume (ml) of components (water/M₁/M₂)are as follows: Sample 1: 5/5/0; Sample 2: 5/4/1; Sample 3: 5/1/4 and Sample 4: 5/0/5. Density of components are: water 1 g/ ml; M₁ 0.87 g/ml and M₂ 1.12 g/ml. In FIG. 4A a heterogeneous mixture is shown. In sample 1 and 2 the organic layer is the upper layer, and for sample 3 and 4, the lower layer. In FIG. 4B, the organic layers (samples 2, 3 and 4) became opaque due to the miscibility with water. According to this experiment it is believed that a water in oil-in-water (w/o/w) emulsion was formed which influences the size of the latex particles developed during polymerization.

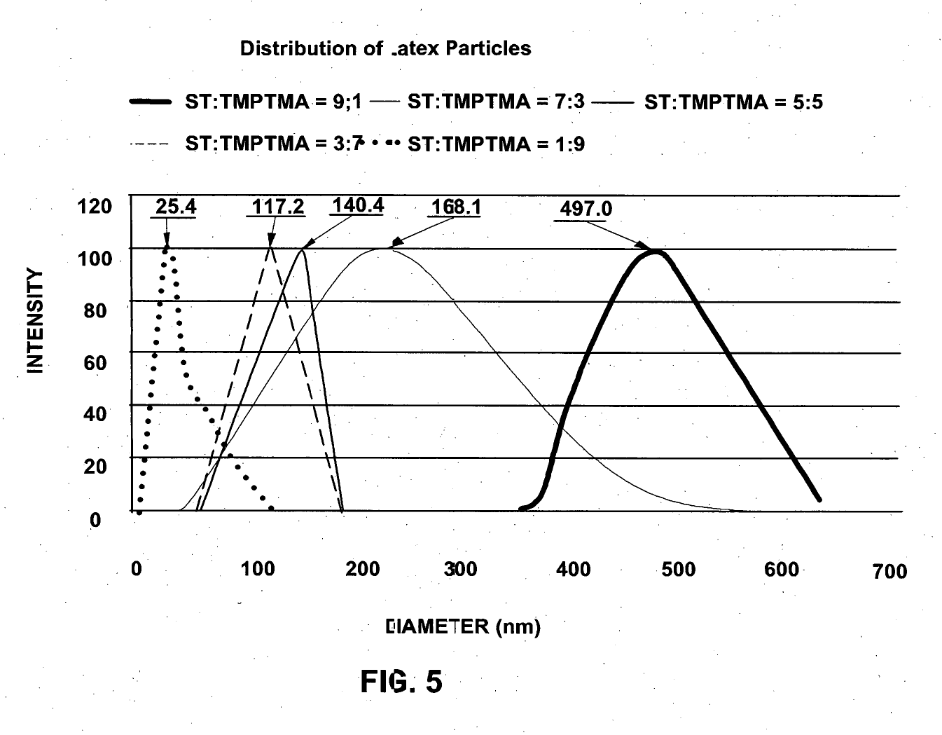

The size of the latex particles was examined in the aqueous continuous phase. Hydrodynamic diameter (H_{D}) of nanoparticles was determined by DLS measurements using BI-200SM Brookhaven photometer equipped with a NdYAg solid state laser at an operating wavelength=532 nm. FIG. 5 shows the particle size of latex using different monomer ratios obtained by oil-in-water miniemulsion copolymerization. The particle size of latex RPNP measured by DLS method. Samples were taken at reaction time 120 min. Ripening of particle was not observed (e.g., for sample with monomer feed M₁/M₂=5/5 size of the latex particles was: at reaction time 20 min: 145.0 nm; 120 min: 144.4 nm; 240 min: 140.4 nm). When the conversion of monomers exceeds 80 %, these values remained constant, for as long as the maximum time it was observed (240 minutes).

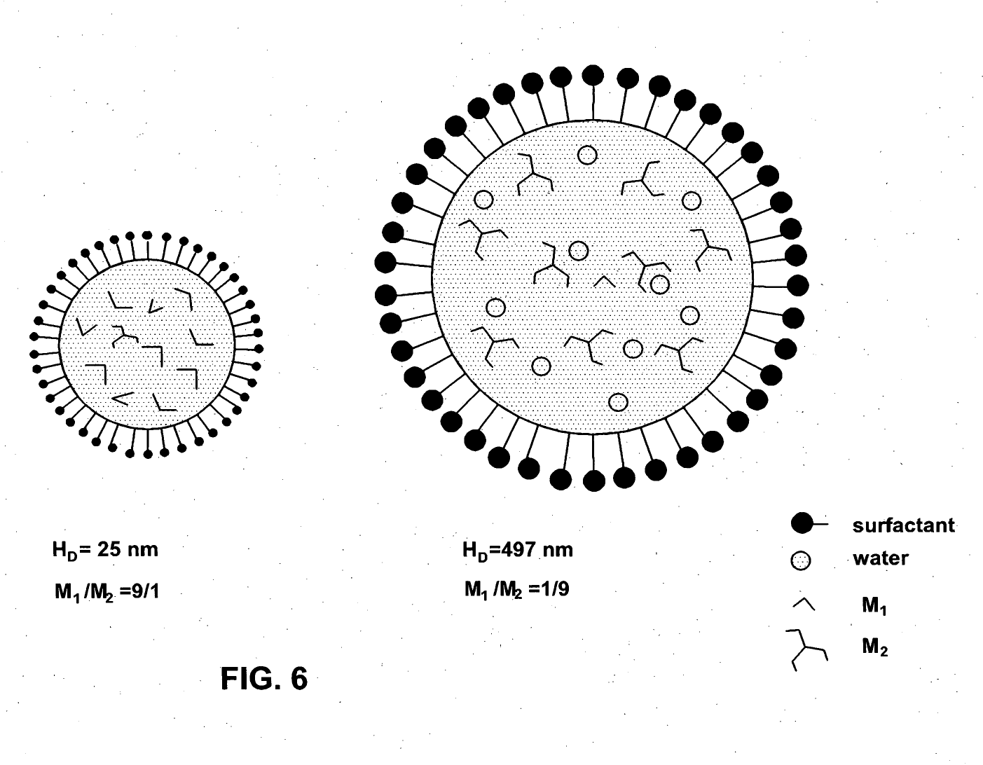

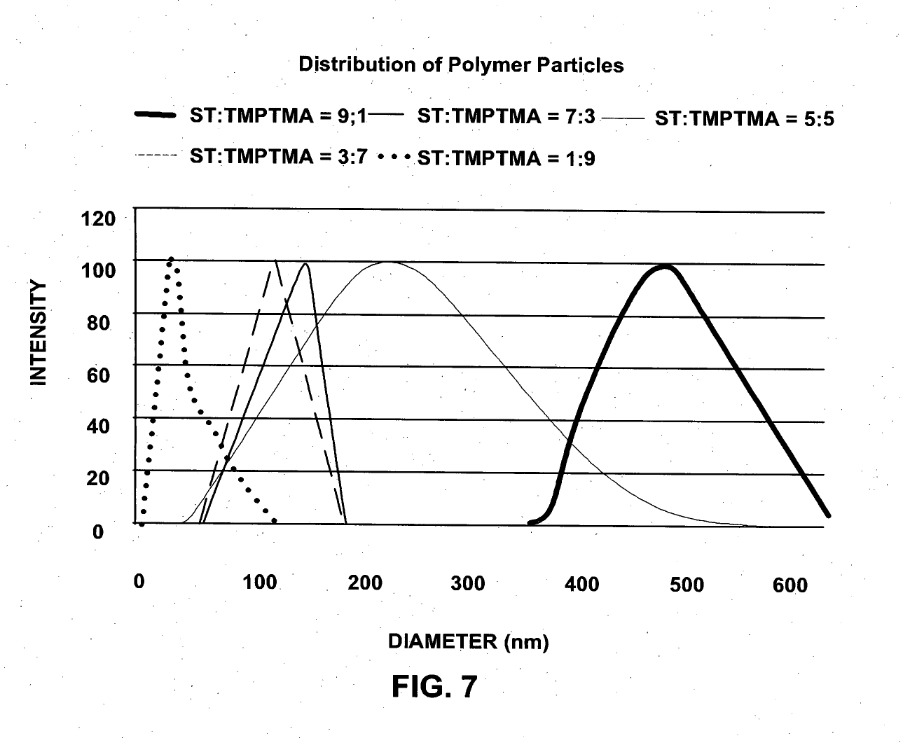

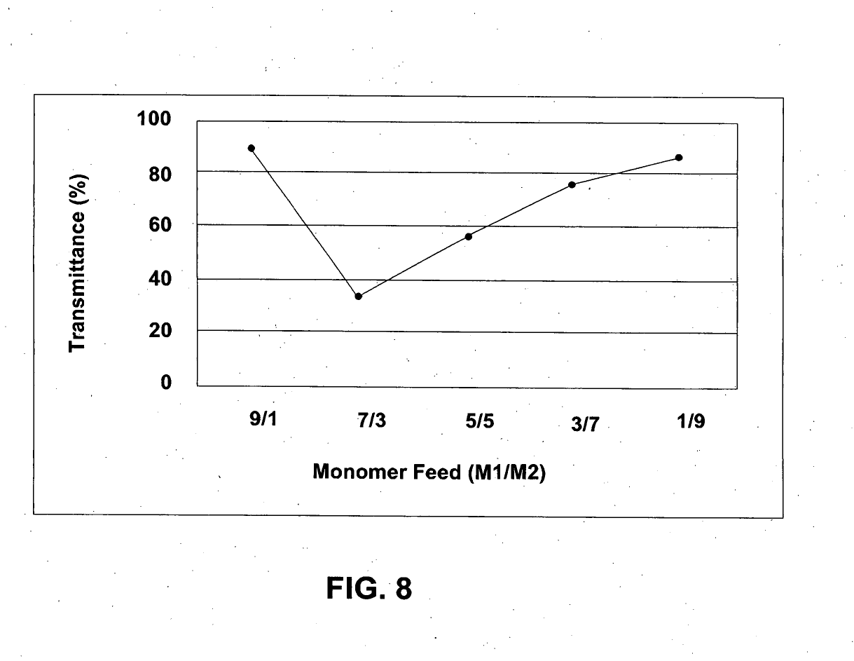

The latex prepared with the monomer ratio M₁/M₂=9/1 is stable at the reaction time of 20 to 120 minutes; the hydrodynamic diameter (H_{D}) measured by DLS was at a maximum of 25.4 nm. However, increasing the monomer ratio of M₂ in the feed resulted in larger latex particles. As it is shown in FIG. 5 the size of particles increased gradually to 497.0 nm. This can be explained by the hydrophobic and hydrophilic nature of the monomers; styrene monomer is highly hydrophobic, but the M₂ monomer, due to the ester linkage, is miscible with water. As shown in FIG. 4 the organic layer becomes opaque as the ratio of M₂ monomer increased. It is believed that a water in oil-in-water (w/o/w) emulsion has been formed when the ratio of M₂ monomer is increasing. In this case, during emulsion polymerization, the dispersed droplets contain the monomers and water, resulting in larger particles. FIG. 6 shows an anticipated composition of nanodroplets before polymerization. After polymerization, the size of latex particles (H_{D}) was determined by DLS method. In measuring the size of the particles, the latex polymer samples were precipitated and then dissolved or dispersed in toluene. The average size of particles was measured by DLS. Crosslinked particles swell in suitable solvents. The swelling ratio depended on the density of crosslinking. The particle size of the unswelled latex increased steadily with increasing ratio of M₂ monomer in the feed; this was due to the reactive pendant vinyl groups. DLS measurements showed different size distribution of polymer nanoparticles (FIG. 7). However, the largest latex particles with highest crosslinking density displayed a reduced swell size. After swelling, the M₁/M₂=5/5 composed particles showed the largest particle size. FIG. 7 shows the particle size of RPNP in toluene as measured by DLS method. The concentration of samples was 0.1 mg/ml in toluene. The size of the particles depended upon two parameters: (i) increasing the M₂ content resulted in an increased particle size, (ii) the crosslinking ratio of larger particles is higher resulting in lower swelling ratio. Because of these two factors, the particles obtained with a monomer feed that is close to M₁/M₂=5/5 presents the largest swelled particle size. Transmittance Studies were also performed. The isolated RPNP were dissolved or dispersed in suitable solvent. Nearly clear or opaque solutions or dispersions were obtained. Transparency measurements were performed with a Unicam SP 1800 Ultraviolet Spectrophotometer at an operating wavelength=600 nm in optically homogeneous quartz cuvettes. Dispersion of RPNPs was prepared in toluene at a concentration of 3 mg/ml. The highest transmittance was observed for sample M₁/M₂=9/1 as smallest particles (H_{D}=66.8 nm) and for sample M₁/M₂=1/9 where the swelling ratio is minimal due to high crosslink density (FIG. 8). FIG. 8 shows the transmittance values of RPNP samples in toluene with concentration of 3 mg/ml. The lowest transmittance value was observed for the sample with composition of M₁/M₂=7/3, which reflects their larger size and their large swelling capacity.

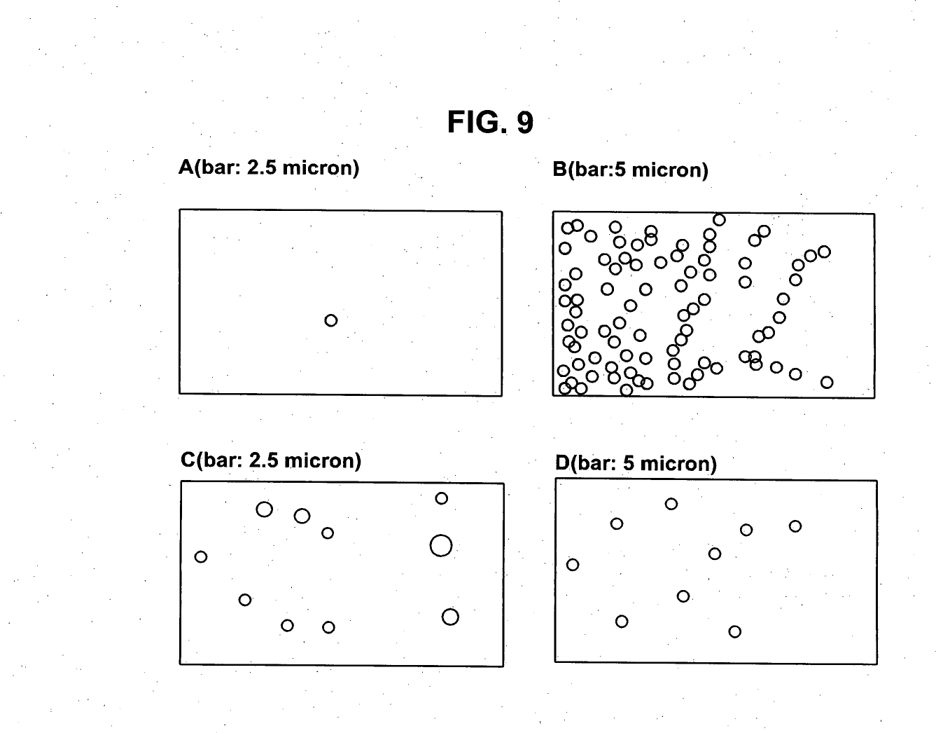

Particle Size was determined by Scanning Electron Microscopy (SEM), SEM measurements were performed on an Hitachi 3000N instrument to determine the particle size of RPNPs. SEM measurements showed that the particle size increased with the ratio of M₂ in the monomer feed. In accordance with the particle size measured for unswelled latex by the DLS method, it was found that the size of dried RPNPs measured by SEM also increased. Selected SEM micrographs are shown in FIG. 9, demonstrating the individual spherical particles. Smallest particles were observed for M₁/M₂=9/1 monomer ratio (100-120 nm). In comparison with the DLS value (H_{D}=66.8 nm), it was observed that these particles on the SEM specimen grids were rather flat spheres. Because of low crosslinking density, the third dimension of these flattened particles was reduced and, therefore, appeared to have a larger diameter.

Polydispersity of particles may be interpreted as a mixture of polymer generations. The particles born in the early stage of polymerization containing reactive vinyl groups may grow larger. Newly born particles at higher conversions remain smaller. In the case of M₁/M₂=1/9 monomer feed, the highest particle size value was observed (300-450 nm).

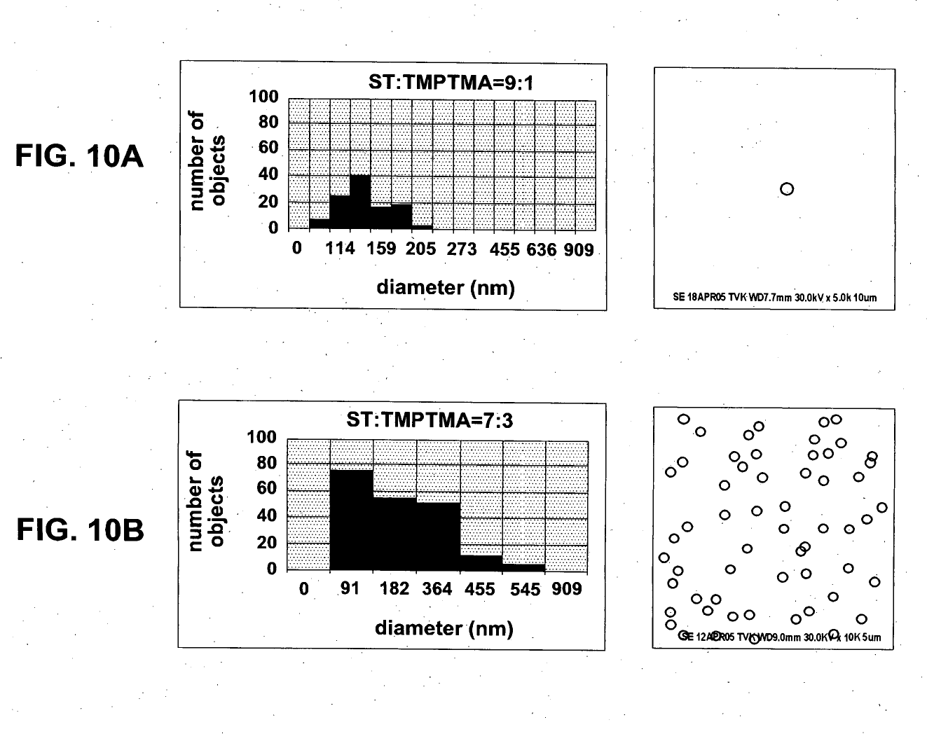

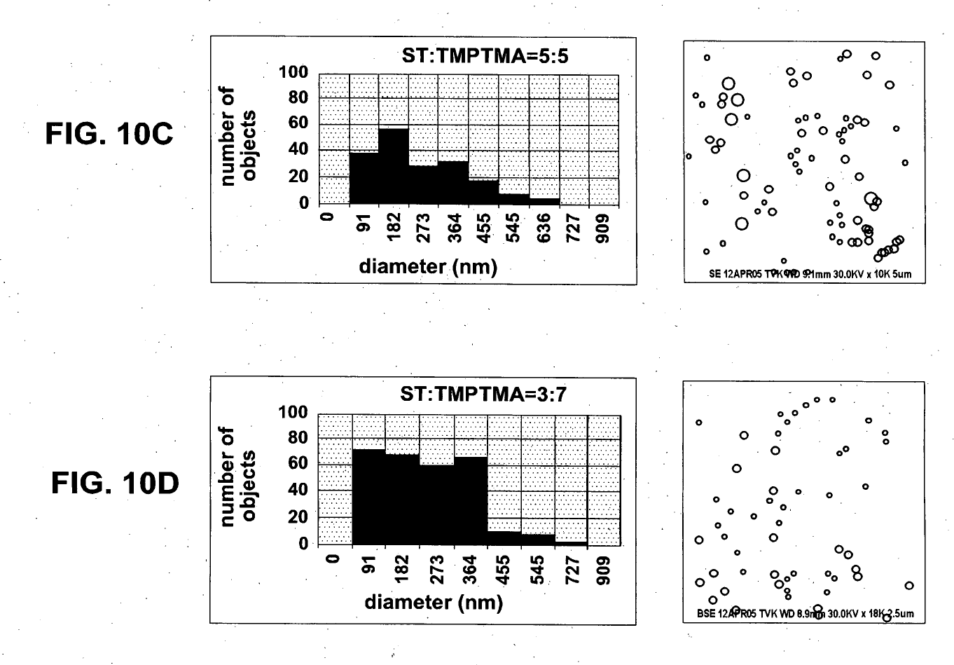

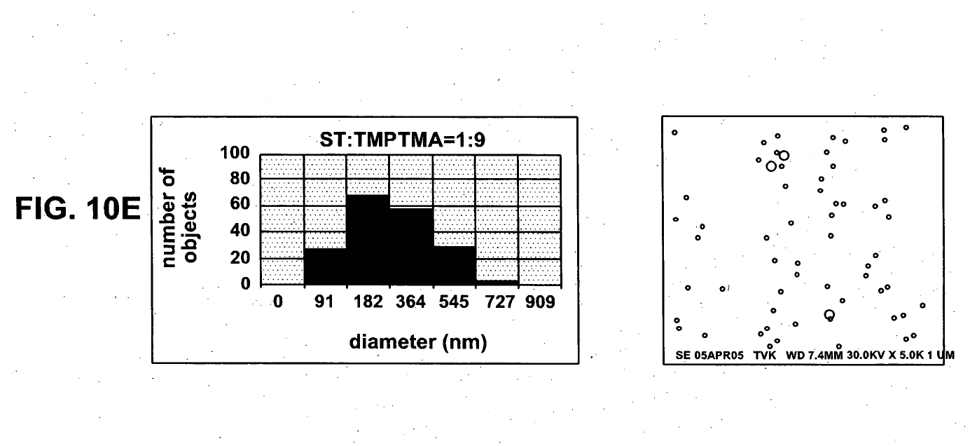

Histograms for demonstration of polydispersity were calculated on the basis of 100 objects or more for each SEM micrograph as shown in FIG. 10.

In FIG. 10, SEM micrographs of RPNPs samples and histograms for size distribution at Bar: 2.5 and 10 micron are shown.

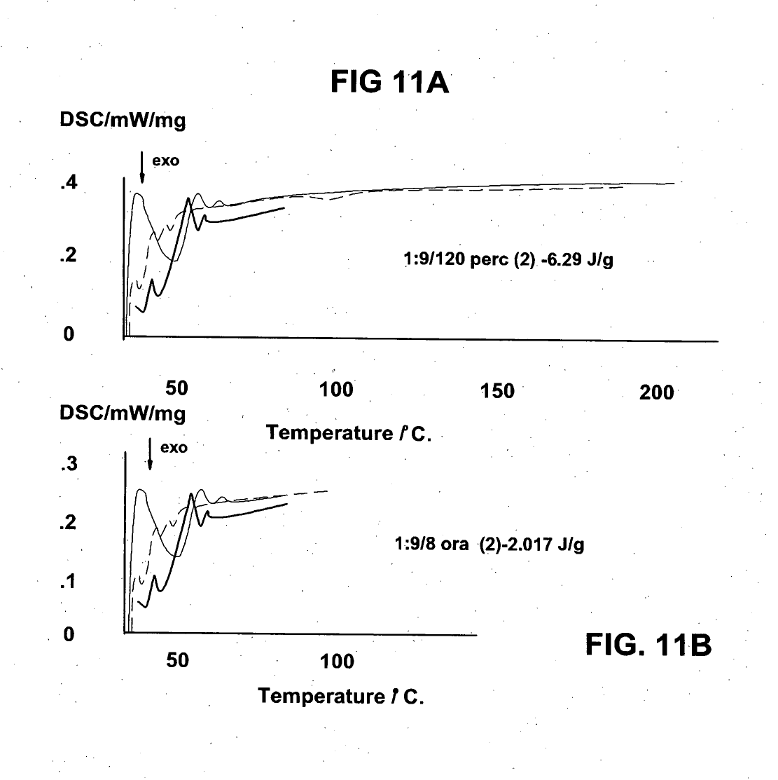

NMR results showed that nanoparticles containing reactive vinyl groups were polymerized at elevated temperature due to thermal initiation. Thermal properties were studied with a Netzsch DSC 204 Phoenix differential scanning calorimeter. Thermograms showed an exotherm peak in the temperature range of 128-173° C., indicating thermoinitiated crosslinking of particles (FIG. 11). The RPNPs prepared by highest M₂ content showed a higher effect. The enthalpy values are summarized in Table 1 below:

TABLE 1
delta H values of samples prepared with different monomer feed and
reaction time.

| Monomer feed | Delta H (J/g) | Delta H (J/g) | Delta H (J/g) |
|---|---|---|---|
| (M₁/M₂) | at 40 min | at 120 min | at 8 hours |
| 1/9 | −7.54 | −6.29 | −2.17 |
| 3/7 | −5.576 | −0.68 | −0.119 |
| 5/5 | −4.897 | −1.52 | −0.51 |

FIG. 11 shows DSC thermograms-of samples with monomer feed of M₁/M₂=1/9 at A: 120 min and B: 480 min reaction time. A line: first run; B line: second run with exoterm peak in the temperature range of 128-173° C. and C line: third run where no peak was observed, the exoterm polymerization was completed. Table 1 summarizes the delta H values of investigated samples.

Reactivity of particles are higher at higher M₂ content. The delta H values above indicate that the prolonged reaction time resulted in the crosslinking reactions of RPNPs. Samples with lower M2 content showed undetectable signals. NMR measurements detected a decrease of the pendant vinyl concentration which is in good agreement with the thermoreactivity of the particles.

### EXAMPLES

### Example 1

Preparation of Reactive Polymer Nanoparticles

Reactive copolymers of ST/TMPTMA were prepared by free radical non-linear emulsion polymerization. The hydrophobic copolymer was formed as follows: 100-ml, three necked, round bottom flask was equipped with paddle stirrer, thermometer, nitrogen inlet, and reflux condenser,under a nitrogen atmosphere. Emulsifier was sodium dodecyl sulphate, initiator was potassium persulfate. Emulsifier, 0.6 grams, and initiator 0.1 mol %, were solubilized in destined water. Monomers, altogether 2.50 grams, was added to continual water phase. The emulsion was stabilized by sonication for 10 minutes. After this the kettle was heated to 60° C. with mixture. At this temperature the initiator decomposed reative sulphate roots which started the non-linear polymerizatin. After the polymerizatin the latex was cleared from the remains emulsifier. It meant dialysis which lasted three days. From the cleaned latex was prepared the polymer by methanol, and it was centrifuged and dryed. After this cleaning the next step was the monomer exemption. From the polymer was prepared 10 m/m % toluene solution ant it was precipitated by methanol and it was again centrifuged. The polymer was characterized by NMR spectroscopy, Transmission Electron Mikroscopy (TEM), Scannin Electron Microscopy (SEM), Dynamic Light Scattering (DLS) and Differential Scanning Calorimetry (DSC). We found that the size of polymeric nanoparticles was influenced by the mol ratio of crosslinker monomer which was Trimethylol propane trimethacrylate (TMPTMA) in this example.

### Example 2

Preparation of MMA/Bis-GMA Nanoparticles

The copolymer was prepared alike to the Example 1.

### Example 3

Preparation of ST/MMA/TMPTMA Reactive Nanoparticles

The copolymer was prepared alike to the Example 2.

### Example 4

Preparation of MMA/Bis-GMA/TMPTMA Reactive Nanoparticles

The copolymer was prepared alike to the Example 3.

### Example 5

Preparation N-benzylmethacrylamide/TMPTMA Reactive Nanoparticles

The N-benzylmethacrylamide solid phase monomer and trimethylol propane trimethacrylate were solubilized in toluene and this solution was dispersed in water by sodium dodecy sulphate as emulsifier. The initiator was αα′ Azoisobutironitrile(AIBN).

What is claimed is:

1. A reactive polymeric nanoparticle comprising the reaction product of a mono vinyl monomer and a di/tri/multivinyl monomer.

2. The polymeric nanoparticle according to claim 1 wherein said monomers are acrylic

3. The polymeric nanoparticle according to claim 1 wherein said nanoparticle is formed in a miniemulsion.

4. The polymeric nanoparticle according to claim 3 wherein said nanoparticle is prepared by a free radical non-linear copolymerization.

5. The polymeric nanoparticle according to claim 4 wherein said mono vinyl monomer is styrene.

6. The polymeric nanoparticle according to claim 4 wherein said mono vinyl monomer is an acrylic/methacrylic ester.

7. The polymeric nanoparticle according to claim 4 wherein said mono vinyl monomer is methyl methacrylate.

8. The polymeric nanoparticle according to claim 4 wherein said trivinyl acrylic monomer is trimethylol propane trimethacrytate.

9. The polymeric nanoparticle according to claim 2 wherein said mono vinyl acrylic monomer is styrene and said trivinyl acrylic monomer is trimethylol propane trimethacrylate.

10. The polymeric nanoparticle according to claim 2 wherein said weight percent of the mono vinyl acrylic monomer to the trivinyl acrylic monomer ranges from about 10% to about 90% by weight.

11. The polymeric nanoparticle according to claim 10 wherein the reaction further comprises one or more surfactants.

12. The polymeric nanoparticle according to claim 10, wherein the reaction further comprises one or more initiators.

13. The polymeric nanoparticle according to claim 11 wherein said surfactant is sodium dodecyl sulfate.

14. The polymeric nanoparticle according to claim 12 wherein said initiator is potassium peroxide.

15. A method of forming reactive polymeric nanoparticles comprising reacting a mono vinyl acrylic monomer with a trivinyl acrylic monomer in a miniemulsion.

16. The method according to claim 15 wherein said reaction is a free radical non-linear copolymerization.

17. The method according to claim 16 wherein said mono vinyl acrylic monomer is a styrene.

18. The method according to claim 17, wherein said trivinyl acrylic monomer is a trimethylol propane trimethacrylate.

19. The method according to claim 18, wherein one or more surfactants is added to the reaction.

20. The method according to claim 19, wherein one or more initiators are added to the reaction.

21. The method according to claim 19, wherein said surfactant is sodium dodecyl sulfate.

22. The method according to claim 20, wherein said initiator is a potassium peroxide.
